(19) United States
(12) Patent Application Publication
(10) Pub. No.: US 2010/0258678 A1
(43) Pub. Date: Oct. 14, 2010

(54) AIRCRAFT STALL PROTECTION SYSTEM

(76) Inventor: NICHOLAS JONATHAN FERMOR, Kirkland, WA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/487,780

(22) Filed: Jun. 19, 2009

Related U.S. Application Data
(60) Provisional application No. 61/202,827, filed on Apr. 9, 2009.

(51) Int. Cl. G05D 1/00; B64C 13/18; G08B 23/00

(52) U.S. Cl. 244/196; 244/194; 340/966

(57) ABSTRACT

A stall protection system for use with an aircraft may have at least one sensor configured to provide an indication of a pressure differential associated with airflow across an airfoil, and a controller in communication with the at least one sensor. The controller may be configured to compare the pressure differential to a pressure differential threshold associated with a stall condition of the airfoil, and to selectively generate a recovery response signal based on the comparison.

### RELATED APPLICATIONS

This application is based on and claims the benefit of priority from U.S. Provisional Application No. 61/202,827 by Nicholas Jonathan Fermor, filed Apr. 9, 2009, the contents of which are expressly incorporated herein by reference.

### TECHNICAL FIELD

The present disclosure is directed to an aircraft system and, more particularly, to an aircraft stall protection system.

### BACKGROUND

Aircraft, in certain situations, can experience a condition known as stall. A stall arises when airflow over an airfoil becomes disrupted (i.e., turbulent) and thereby reduces lift generated by the airflow. If unaccounted for, the reduced lift in a stall could fall below a minimum lift required to maintain the aircraft aloft.

To help reduce the likelihood of stall, aircraft are often equipped with a stall warning system providing an alert of an impending stall condition in time for a pilot to engage evasive maneuvers that help the aircraft avoid full stall. Most existing stall warning systems include an angle-of-attack (AOA) sensor that measures an inclination of the airfoil relative to a travel direction of the airfoil. Under ideal conditions, the AOA of the airfoil can be directly related to the onset of stall. That is, for a given airfoil operating under ideal conditions, a known AOA can predictably produce stall. Thus, if the AOA can be monitored and maintained below a critical AOA, stall can be safely avoided.

However, ideal conditions are not always present during operation of an aircraft. That is, in some situations, the airfoil can become contaminated with frost, ice, debris, or other contaminates. In these situations, it may be possible for stall to occur at angles less than the critical AOA.

The disclosed aircraft stall protection system is directed to at least partially overcoming one or more drawbacks of the related art.

### SUMMARY

In the following description, certain aspects and embodiments of the present invention will become evident. It should be understood that the invention, in its broadest sense, could be practiced without having one or more features of these aspects or embodiments. In other words, these aspects and embodiments are merely exemplary.

One aspect of the present disclosure is directed to an aircraft stall protection system. The aircraft stall protection system may include at least one sensor configured to provide an indication of a pressure differential associated with airflow across an airfoil, and a controller in communication with the at least one sensor. The controller may be configured to compare the pressure differential to a pressure differential threshold associated with a stall condition of the airfoil, and to selectively generate a recovery response signal based on the comparison.

Another aspect of the present disclosure is directed to a method of addressing stall of an aircraft. The method may include measuring a pressure differential associated with airflow across an airfoil, and comparing the pressure differential to a pressure differential threshold associated with a stall condition of the airfoil. The method may further include selectively generating a recovery response signal based on the comparison.

### BRIEF DESCRIPTION OF THE DRAWINGS

It is to be understood that both the foregoing general description and the following detailed description are exemplary and explanatory only and are not restrictive of the invention. The accompanying drawings, which are incorporated in and constitute a part of this specification, illustrate several exemplary embodiments of the invention and together with the description, serve to explain principles of the invention.

FIG. 1 is a schematic and diagrammatic illustration of an exemplary disclosed aircraft;

FIG. 2 is a diagrammatic illustration of an exemplary disclosed stall protection system that may be used in conjunction with the aircraft of FIG. 1; and

FIG. 3 is a flowchart depicting an exemplary disclosed operation performed by the stall protection system of FIG. 2.

### DETAILED DESCRIPTION OF EMBODIMENTS

Reference will now be made in detail to exemplary embodiments of the invention, examples of which are illustrated in the accompanying drawings. Wherever possible, the same reference numbers will be used throughout the drawings to refer to the same or like parts.

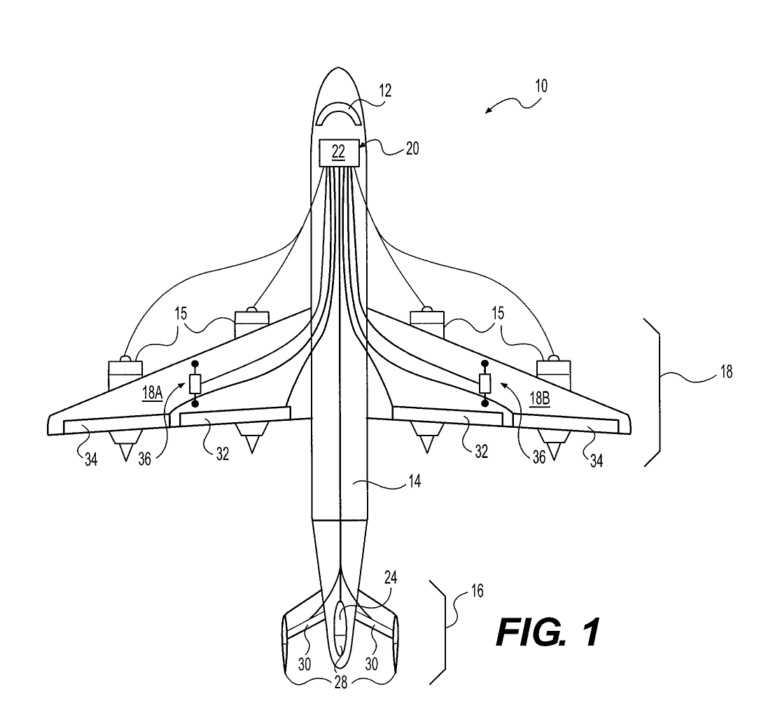

FIG. 1 illustrates an exemplary aircraft 10. For the purposes of this disclosure, aircraft 10 is depicted and described as an airplane including a cockpit 12, a fuselage 14, a source of power 15, an empennage 16, and wings 18. Cockpit 12, the source of power 15, empennage 16, and wings 18 may connect to and be supported by fuselage 14. Aircraft 10 may be any type airplane, such as, prop, jet, or other type. The depicted implementation is merely exemplary, and other implementations may also be used.

Cockpit 12 may be configured to receive input from an operator indicative of a desired operation of aircraft 10, for example a flight control operation. For this reason, cockpit 12 may include one or more operator interface devices (not shown) embodied as single or multi-axis joysticks, pedals, steering wheels and/or columns, knobs, switches, gauges, displays, and other similar on/off or proportional-type control devices configured to receive manual input and responsively initiate, cancel, alter, and/or display an operation of aircraft 10.

In some embodiments, cockpit 12 may be equipped with a central control system, for example an autopilot system 20 that enhances, facilitates, or even completely replaces manual control of particular functions of aircraft 10. In one embodiment, autopilot system 20 may autonomously adjust flight control operations such as flap, aileron, elevator, and/or rudder movements, as will be described in greater detail below. Autopilot system 20 may include a controller 22 in communication with different components of aircraft 10.

Fuselage 14 may contain a frame (not shown), panel sections operatively connected to the frame, passenger seats (not shown), passenger access doors (not shown), luggage access doors (not shown), and/or windows (not shown). Fuselage 14 may also contain engine, empennage, and wing attachment hardware, and generally function as a central support structure of aircraft 10.

The source of power 15 for aircraft 10 may include an engine, for example a jet engine, a rotary piston engine that drives a propeller, or any other type of engine and thrust generator known in the art. The engine may be selectively supplied with fuel and air, which may be mixed together and ignited within the engine to produce thrust that propels aircraft 10. The mixture and/or quantity of fuel and air provided to the engine may be manually controlled via operator interface devices within cockpit 12 and/or controlled autonomously by autopilot system 20 in response to various input to thereby provide a desired level of thrust.

Empennage 16 may be a separate component of aircraft 10 or an integral part of fuselage 14, and contain one or more vertical stabilizers 24 and one or more horizontal stabilizers 26. At least one rudder 28 or other similar control device may be pivotally attached to or integral with vertical stabilizers 24, and selectively adjusted to affect yaw of aircraft 10. Similarly, at least one elevator 30 or other similar control device may be pivotally attached to or integral with horizontal stabilizers 26, and selectively adjusted to affect elevation (i.e., climb or descent) of aircraft 10. Operation of rudders 28 and/or elevators 30 may be manually controlled via operator interface devices located within cockpit 12 and/or controlled autonomously by autopilot system 20 in response to various input.

Wings 18 may generally include a left airfoil 18A and a right airfoil 18B connected to fuselage 14 by spars (not shown) and/or other connecting hardware (not shown). Any configuration of wings may be used by aircraft 10 such as a bi-wing configuration, a tri-wing configuration, or any other wing configurations. In addition, a canard (not shown) and winglets (not shown) may also be used in conjunction with aircraft 10, if desired. Aircraft 10 may be a low-wing, high-wing, mid-wing, or other wing-design aircraft. One or more flaps 32 and/or other similar control devices may be pivotally and/or slidably attached to wings 18, and selectively adjusted to affect lift and drag of aircraft 10. Similarly, one or more ailerons 34 and/or other similar control devices may be pivotally and/or slidably attached to wings 18, and selectively adjusted to affect roll of aircraft 10. Operation of flaps 32 and/or ailerons 34 may be manually controlled via operator interface devices located within cockpit 12 and/or controlled autonomously by autopilot system 20 in response to various input.

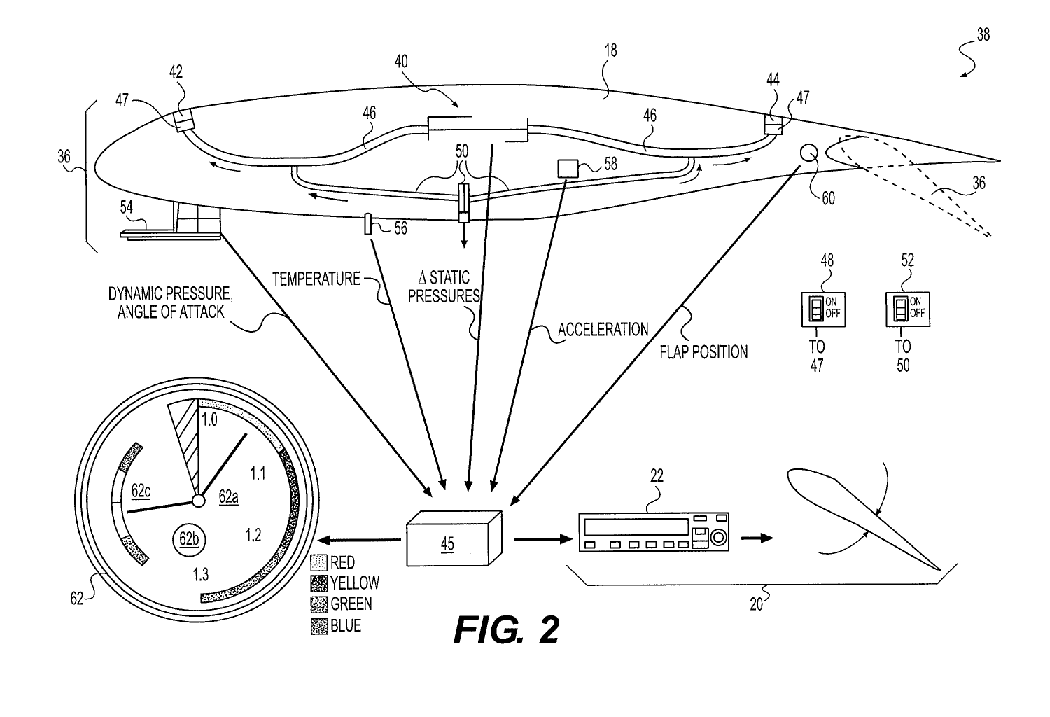

During control of aircraft 10, it may be of interest to monitor stall conditions of wings 18. For this purpose, a stall monitoring arrangement 36 may be associated with each airfoil 18A and 18B. As shown in FIG. 2, autopilot system 20, together with stall monitoring arrangement 36, may form a stall protection system 38. Operation of stall protection system 38 will be described in more detail below.

Stall monitoring arrangement 36 may include at least one sensor 40 configured to measure a differential pressure across each airfoil 18A and 18B. Although multiple sensing elements may be utilized, in the embodiment shown in FIG. 2, sensor 40 may be a differential pressure sensor having a single sensing element associated with multiple ports, for example a first static port 42 located toward a leading edge of wing 18, and a second static port 44 located toward a trailing edge of wing 18. First and second static ports 42, 44 may be located on an upper surface of each airfoil 18A, 18B, aligned in a chord-wise direction at a single span-wise location, and connected to sensor 40 by way of passages 46 internal to wings 18. Sensor 40 may be configured to generate a signal indicative of a difference of air pressure at first and second static ports 42, 44, and to direct this signal to a controller 45 of stall protection system 38.

Each of controllers 22 and 45 may embody a single or multiple microprocessors, field programmable gate arrays (FPGAs), digital signal processors (DSPs), etc., that include a means for controlling an operation of aircraft 10 in response to signals received from various sensory devices and/or human operators Numerous commercially available microprocessors can be configured to perform the functions of controllers 22 and/or 45. It should be appreciated that one or both of controllers 22 and 45 could readily embody a general aircraft microprocessor capable of controlling numerous system functions and modes of operation. Various other known circuits may be associated with controllers 22 and 45, including power supply circuitry, signal-conditioning circuitry, actuator driver circuitry (i.e., circuitry powering solenoids, motors, or piezo actuators), communication circuitry, and other appropriate circuitry.

In some embodiments, stall monitoring arrangement 36 may be provided with heating and/or purging capabilities to promote extended operation during unfavorable conditions. In one example, a heating element 47 may be associated with each of first and second static ports 42, 44. Heating elements 47 may be selectively activated by way of a manual switch 48 located within cockpit 12. A purge/drain circuit 50 may also be associated with each of first and second static ports 42, 44 to help clear passages 46 of contaminates. Similar to heating elements 47, purge/drain circuit 50 may also be selectively activated by way of a manual switch 52 located within cockpit 12. Alternatively or additionally, any of heating elements 47 and purge/drain circuit 50 may be activated autonomously by stall protection system 38 in response to various inputs, if desired.

One or both of left and right airfoils 18A and 18B may also be equipped with additional sensing devices to facilitate operation of stall protection system 38. For example, a pitot tube/angle-of-attack sensor 54, a temperature sensor 56, an acceleration sensor 58, a flap position sensor 60, and/or any other sensors may be attached to wings 18 or any other portion of aircraft 10. Each of these sensors may be configured to generate signals directed to one or both of controllers 22 and 45.

Based on input from sensors 40, 54, 56, 58, 60, and/or additional sensors, controller 45 of stall protection system 38 may selectively provide indications of flight conditions via one or more displays 62 located within cockpit 12. One exemplary display 62 is shown in FIG. 2 as being associated with stall margin, stall warning, and ice accretion conditions. In particular, display 62 is shown to include a first dial-type indicator 62a having a needle movable from an area of acceptable stall margin (normally shown in green) through an area of reduced stall margin (normally shown in yellow), to an area of unacceptable stall margin (normally shown in red). As the needle moves from the green area toward the red area, this would provide the human pilot of aircraft 10 with a visual prompt to begin evasive maneuvers to return the needle to the green area. Display 62 also includes a light 62b that is selectively illuminated as measured conditions of wings 18 actually achieve stall. When light 62b becomes illuminated, autopilot system 20 may be triggered to override manual control of aircraft 10 and autonomously improve flight conditions, as will be described in more detail below. Display 62 also includes a second dial-type indicator 62c having a needle movable from an area of zero ice accretion (normally shown in green), toward an area of unacceptable ice accretion (normally shown in blue). It is contemplated that one or both of first and second dial-type indicators 62a and 62c may be indexed in any manner.

Controller 45 may determine stall margin for display 62 by calculating a non-dimensionalized pressure coefficient (Cₚ,) and comparing that coefficient with a peak coefficient particular to aircraft 10 (i.e., a maximum lift coefficient corresponding to stall conditions particular to aircraft 10). The non-dimensionalized pressure coefficient may be calculated as a function of the differential pressure measured by sensor 40, and of a dynamic pressure measured by sensor 54. When the stall margin calculated by controller 45 becomes less than a threshold stall margin, wings 18 can be considered in full stall.

In some embodiments, to help minimize false alerts of the stall condition, a rate of change of the non-dimensionalized differential pressure (Ċₚ) may also be considered. That is, in some embodiments, the threshold stall margin may include both a magnitude component and a rate of change component. In these embodiments, light 62b may only be illuminated when the stall margin value calculated by controller 45 becomes less than the threshold stall margin value in magnitude (actual stall conditions are measured), and when the rate of change of the differential pressure measured by sensor 40 is less than a threshold rate of change (i.e., when the measured differential pressure is substantially consistent).

Controller 45 may determine ice accretion for display 62 by comparing signals from sensor 40 with signals from sensor 54. In particular, under normal conditions (when minimal amounts of ice or other contaminates have accumulated on wings 18), the angle-of-attack of wings 18, as measured by sensor 54, can be directly related to stall margin. Thus, the angle-of-attack measured by sensor 54 could provide an indication of stall margin that substantially corresponds with the indication of stall margin measured by sensor 40 and calculated by controller 45 when wings 18 are substantially free of contamination. Therefore, a comparison of the signals from sensor 40 with the signals generated by sensor 54 may provide an indication of wing contamination. For example, when the stall margin calculated by controller 45 based on signals from sensor 40 substantially matches the stall margin indicated by the AOA measured by sensor 54, it can be concluded that relatively little, if any, contamination exists. However, if the stall margin calculated by controller 45 based on the signals from sensor 40 is significantly different from the stall margin indicated by sensor 54, contamination in an amount proportional to the difference may exist. For this reason, controller 45 may continually compare the signals from sensor 40 with the signals from sensor 54, and provide the second dial-type indicator 62c with information for display that is related to this comparison.

Based on measured and/or calculated flight conditions, controller 45 of stall protection system 38 may selectively generate recovery response signals directed to controller 22 of autopilot system 20. In particular, when the stall margin, as calculated by controller 45, becomes less than the threshold stall margin in magnitude and when the rate of change of the differential pressure measured by sensor 40 is less than a threshold rate of change, autopilot system 20 may be triggered to implement maneuvers that reduce the stall condition (i.e., that improve stall margin). For example, in response to the recovery response signals from controller 45, controller 22 may cause a reduction in the angle-of-attack of airfoils 18A and/or 18B by raising flaps 32. Alternatively or additionally, controller 22 may control the source of power 15 to increase thrust and thereby the airspeed of aircraft 10. A reduction in the attack angle of wings 18 and/or an increase in airspeed may help to improve the stall margin of aircraft 10. It is contemplated that, after receiving the recovery response signals, controller 22 may additionally control operation of ailerons 34, rudder 28, and/or elevators 30 to improve stall margin, if desired. At any point in time during operation of autopilot system 20, a human pilot of aircraft 10 can resume control thereof by manual manipulation of the operator interface devices located within cockpit 12.

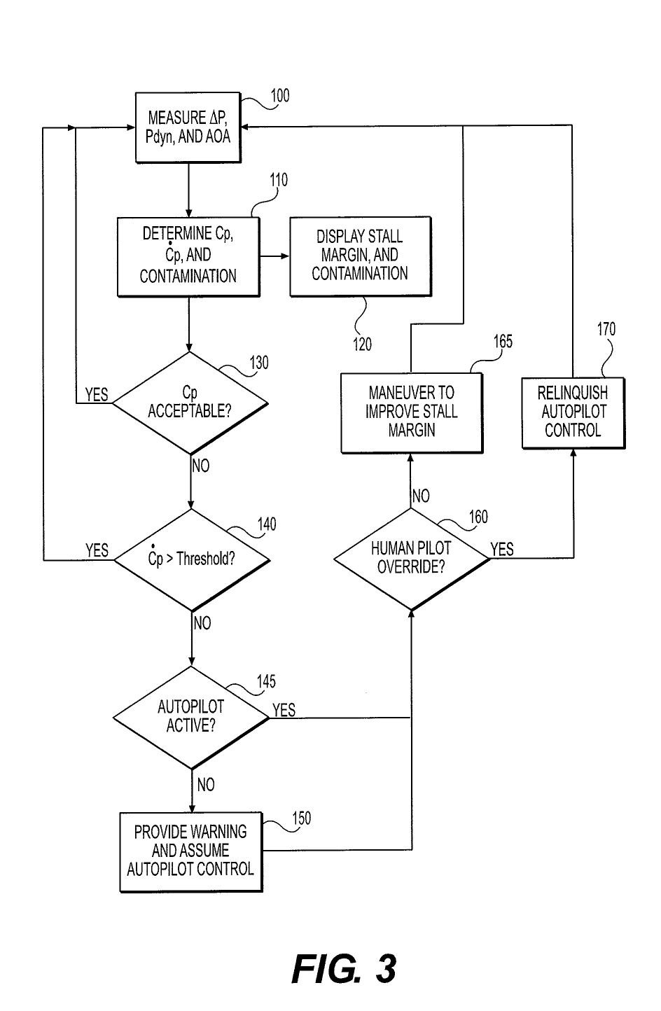

FIG. 3 illustrates an exemplary operation performed by stall protection system 38.

FIG. 3 will be discussed in more detail in the following section to further illustrate examples of particular features.

### INDUSTRIAL APPLICABILITY

The stall protection system of the present disclosure may be applicable to any aircraft where stall conditions are a concern. The disclosed stall protection system may help an aircraft avoid stall conditions by providing accurate measurements of wing air pressures corresponding to stall margins to a pilot of the aircraft. The disclosed stall protection system may also help prevent stall conditions and/or facilitate recovery from stall conditions by selectively implementing autonomous control of the aircraft based on direct measurement of airfoil stall. Operation of stall protection system 38 will now be described.

As illustrated in the flowchart of FIG. 3, operation of stall protection system 38 may begin by measuring the pressure differential across one or both of airfoils 18A and 18B of wings 18 by way of sensor 40. The angle-of-attack of wings 18 and the dynamic pressure at the leading edge of wings 18 may also be measured at this time by way of sensor 54. (Step 100).

Based on signals from sensors 40 and 54, controller 45 may determine the non-dimensionalized pressure coefficient Cₚ as a function of the differential pressure signals from sensor 40 and the dynamic pressure signals from sensor 54 (i.e., Cₚ=ƒ(ΔP,P_{dyn})). At this same point in time, the rate of change of the pressure differential, or more accurately the rate of change of the non-dimensionalized pressure coefficient (Ċₚ), may also be determined by monitoring a change in the signals from sensor 40 over time. (Step 110).

Once Cₚ has been calculated, controller 45 may control display 62 to provide an indication of stall margin and wing contamination levels. (Step 120). The displayed stall margin may be, for example, a ratio of the peak coefficient to the non-dimensionalized pressure coefficient calculated by controller 45. The wing contamination levels may be, for example, a ratio of a stall margin value determined based on the non-dimensionalized pressure coefficient to a stall margin value determined based on the angle-of-attack of wings 18.

Additionally, controller 45 may compare the non-dimensionalized coefficient of pressure to a threshold value. This comparison may include both a comparison of the magnitudes (Step 130) and a comparison of the rates of change (Step 140). If the comparisons reveal the magnitude of the non-dimensionalized pressure coefficient is less than a threshold value (i.e., if Cₚ has an acceptable value), control may return from Step 130 to Step 100. If the comparisons reveal the rate of change of the non-dimensionalized pressure coefficient is greater than a threshold rate, control may similarly return from Step 140 to Step 100. However, if the comparisons reveal the magnitude of the non-dimensionalized pressure coefficient is greater than the threshold value and the rate of change of the non-dimensionalized pressure coefficient is less than the threshold rate, controller 45 may then check to see if autopilot system 20 is already active. (Step 145). If at step 145, autopilot system 20 is not yet active, controller 45 may cause light 62b to be illuminated, thereby warning the pilot of aircraft 10 of imminent or already occurring stall conditions, and generate the recovery response signal directed to autopilot system 20. The recovery response signal may trigger autopilot system 20 to assume autonomous control over flight operations of aircraft 10. (Step 150). If, however, at step 145, autopilot system 20 is already active, control may skip step 150.

At any time during autopilot control over flight maneuvers, a human pilot may resume control of aircraft 10 by manipulating any of the operator interface devices located within cockpit 12 past a required degree. Thus, stall protection system 38 may continually monitor operator input (Step 160) and, when the required degree of operator input has been observed, autonomous control of aircraft 10 may be relinquished (Step 170).

Without operator interference, autopilot system 20 may maneuver aircraft 10 during measured stall conditions to improve stall margin. (Step 165). That is, autopilot system may cause flaps 32 to rise, may cause aircraft 10 to pitch forward, may cause the source of power 15 to increase thrust, and/or may implement other or additional maneuvers that increase the lift of wings 18. Unless manually overridden, autopilot control over flight operations may continue to loop through steps 100-165 until an acceptable stall margin is regained, and thereafter control may loop through steps 100-140.

Because stall protection system 38 may function directly off of measured stall (i.e., off of pressure differentials measured across airfoils 18A and 18B), the stall margin and stall warning provided by stall protection system 38 may be accurately and reliably implemented. In addition, because stall protection system 38 provides autonomous stall recovery control, aircraft 10 may benefit from additional protection.

Other embodiments will be apparent to those skilled in the art from consideration of the specification and practice of the subject matter disclosed herein. It is intended that the specification and examples be considered as exemplary only.

What is claimed is:

1. An aircraft stall protection system, comprising:
at least one sensor configured to provide an indication of a pressure differential associated with airflow across an airfoil; and
a controller in communication with the at least one sensor, the controller being configured to compare the pressure differential indicated by the at least one sensor, to a pressure differential threshold associated with a stall condition of the airfoil, and to generate a recovery response signal based on the comparison.

2. The aircraft stall protection system of claim 1, wherein the pressure differential threshold includes a magnitude component and a rate of change component.

3. The aircraft stall protection system of claim 2, wherein the controller is configured to:
determine a stall margin value based on a comparison of the pressure differential with the magnitude component; and
determine actual occurrence of stall based on a comparison of a rate of change of the pressure differential with the rate of change component.

4. The aircraft stall protection system of claim 3, further including an angle-of-attack sensor, wherein:
the stall margin value determined based on the comparison of the pressure differential with the magnitude component is a first stall margin value; and
the controller is further configured to
determine a second stall margin value based on input from the angle-of-attack sensor,
compare the first stall margin value to the second stall margin value, and
determine a contamination of the airfoil when the first stall margin value is significantly different from the second stall margin value.

5. The aircraft stall protection system of claim 2, wherein the controller is configured to generate the recovery response signal only when the pressure differential indicated by the at least one sensor exceeds the magnitude component and a determined rate of change of the pressure differential is less than the rate of change component.

6. The aircraft stall protection system of claim 1, wherein the at least one sensor is a single differential pressure sensor associated with multiple static ports.

7. The aircraft stall protection system of claim 6, wherein the multiple static ports are located in a chord-wise direction.

8. The aircraft stall protection system of claim 7, wherein the multiple static ports are located at a single span-wise location.

9. The aircraft stall protection system of claim 6, further including:
passages connecting the multiple static ports to the single differential pressure sensor; and
a purge circuit configured to remove contaminates from the passages.

10. The aircraft stall protection system of claim 6, further including at least one heating element configured to provide heat to the multiple static ports.

11. The aircraft stall protection system of claim 1, further including a display configured to provide an indication of a stall condition based on the recovery response signal.

12. The aircraft stall protection system of claim 11, wherein the indication of a stall condition includes a stall margin.

13. The aircraft stall protection system of claim 12, wherein the indication of a stall condition further includes illumination of a warning light when the stall margin falls below a threshold level.

14. The aircraft stall protection system of claim 1, further including an autopilot system configured to autonomously control flight operations of an aircraft to improve stall margin, wherein the recovery response signal triggers operation of the autopilot system.

15. The aircraft stall protection system of claim 14, wherein the autopilot system is configured to override manual control of the aircraft in response to the recovery response signal.

16. The aircraft stall protection system of claim 15, wherein the autopilot system is configured to selectively relinquish autonomous control of flight operations in response to manual input.

17. The aircraft stall protection system of claim 14, further including at least one of a temperature sensor, an acceleration sensor, a pitot tube sensor, and a flap position sensor, the autopilot system being configured to control flight operations based on input from the at least one of the temperature sensor, the acceleration sensor, the pitot tube sensor, and the flap position sensor

18. A method of addressing stall of an aircraft, comprising:
measuring a pressure differential of airflow across an airfoil;
comparing the measured pressure differential to a pressure differential threshold associated with a stall condition of the airfoil; and
generating a recovery response signal based on the comparison.

19. The method of claim 18, wherein the pressure differential threshold includes a magnitude component and a rate of change component.

20. The method of claim 19, further including:
determining a stall margin value based on a comparison of the pressure differential with the magnitude component; and
determining actual occurrence of stall based on a comparison of a rate of change of the pressure differential with the rate of change component.

21. The method of claim 20, wherein:
the stall margin value determined based on the comparison of the pressure differential with the magnitude component is a first stall margin value; and
the method further includes
measuring an angle-of-attack of the airfoil;
determining a second stall margin value based on the measured angle-of-attack;
comparing the first stall margin value to the second stall margin value, and
determining a contamination of the airfoil when the first stall margin value is significantly different from the second stall margin value.

22. The method of claim 19, wherein generating the recovery response signal includes generating the recovery response signal only when the measured pressure differential exceeds the magnitude component and a determined rate of change of the pressure differential is less than the rate of change component.

23. The method of claim 18, wherein measuring a pressure differential includes measuring a pressure differential in a chord-wise direction at a single span-wise location.

24. The method of claim 18, further including displaying an indication of a stall condition based on the recovery response signal.

25. The method of claim 24, wherein displaying the indication of a stall condition includes displaying a stall margin.

26. The method of claim 25, wherein displaying the indication of a stall condition further includes illuminating a warning light when the stall margin falls below a threshold level.

27. The method of claim 18, further including initiating autonomous control of flight operations to improve stall margin based on the recovery response signal.

28. The method of claim 27, wherein initiating autonomous control of flight operations includes overriding manual control.

29. The method of claim 28, further including relinquishing autonomous control of flight operations in response to manual input.

30. The method of claim 18, further including:
measuring at least one of a temperature, an acceleration, a dynamic pressure, and a flap position; and
controlling flight operations based on the measured at least one of the temperature, the acceleration, the dynamic pressure, and the flap position.

31. An aircraft, comprising:
an airfoil;
a differential pressure sensor configured to provide an indication of a pressure differential associated with airflow across the airfoil;
an autopilot system configured to autonomously control flight operations of the aircraft; and
a controller in communication with the at least one sensor and the autopilot system, the controller being configured to:
compare the pressure differential indicated by the differential pressure sensor to a pressure differential threshold associated with a stall condition of the airfoil, the pressure differential threshold having a magnitude component and a rate of change component;
determine a stall margin value based on a comparison of the pressure differential with the magnitude component;
provide an indication of the stall margin value to a pilot of the aircraft;
determine actual occurrence of stall based on a comparison of a rate of change of the pressure differential with the rate of change component; and
trigger operation of the autopilot system to increase stall margin based on the actual occurrence of stall.

32. The aircraft of claim 31, further including an angle-of-attack sensor, wherein the stall margin value determined based on the comparison of the pressure differential with the magnitude component is a first stall margin value, and wherein the controller is further configured to:
determine a second stall margin value based on input from the angle-of-attack sensor;
compare the first stall margin value to the second stall margin value; and
determine a contamination of the airfoil when the first stall margin value is different from the second stall margin value.
